(19) United States
(12) Patent Application Publication
(10) Pub. No.: US 2006/0253551 A1
(43) Pub. Date: Nov. 9, 2006

(54) System and method of sharing data using server in broadband network

(75) Inventor: Hae-sik Jun, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/387,932

(22) Filed: Mar. 24, 2006

(30) Foreign Application Priority Data
Mar. 24, 2005 (KR) 10-2005-0024545

(51) Int. Cl. G06F 15/16

(52) U.S. Cl. 709/219

(57) ABSTRACT

A data sharing system and method using a server in a broadband network are provided. The system includes: a data sharing server which provides a space for sharing the data; a data providing terminal which transmits generated data to the data sharing server based on a transmission profile which defines data transmission schemes; and a data receiving terminal which receives the data from the data sharing server based on a reception profile which defines data transmission scheme.

### CROSS-REFERENCE TO RELATED PATENT APPLICATION

This application claims priority from Korean Patent Application No. 10-2005-0024545, filed on Mar. 24, 2005, in the Korean Intellectual Property Office, the disclosure of which is incorporated herein in its entirety by reference.

### BACKGROUND OF THE INVENTION

1. Field of the Invention

The present invention relates to a technique for sharing data, such as contents data, in a network, and more particularly, to a system and method of sharing data, such as contents data, by using a server in a broadband network.

2. Description of Related Art

Recently, digital apparatuses such as a digital camera, a camera phone, and a digital camcorder have been widely provided to users, so that digital data, such as contents data, obtained and possessed by personal users have greatly increased. In addition, the personal users desire to share a variety of the data with friends, family, or comrades. The sharing of the data is mainly implemented by using physical media such as a memory card, a digital video disk (DVD), or a personal computer in a home. However, the sharing method inconveniently requires a user's participation in a large number of processes in order to share the data.

Now, a conventional system for sharing data will be described with reference to FIG. 1.

The system shown in FIG. 1 includes a computer 100, the Internet 200, a contents providing system 300, a personal information processing unit 400, and a cradle 500.

The computer 100 includes an auto-sync program 110 constructed with a data processing program 110a, a communication program 110b, and a driver 110c, an operating system 130, and a universal serial bus (USB) port 140.

The contents providing system 300 includes a database (DB) server 310 for managing accounts and a web service server 320. The cradle 500 functions as a supporting bed for the personal information processing unit 400 and connects the USB port 140.

Now, operations of sharing the data by using the system shown in FIG. 1 will be described. A user downloads the data generated by a digital still camera (DSC) or a digital video camera (DVC) to the computer 100. The user uploads the data downloaded to the computer 100 to the contents providing system 300 through the Internet 200.

After that, the user accesses the contents providing system 300 by using a computer and downloads the data in the contents providing system by using the auto-sync program 110. After a display apparatus is selected based on the type of the downloaded data, the data is transmitted to the display apparatus through the USB port, IEEE 1394, or an Ethernet.

Therefore, if personal users share data by using a personal computer and the Internet, there are many cases that the users must participate in the individual processes. Namely, a user accesses the server and directly uploads the data. A user receiving the data selects a display apparatus suitable for the data and directly transmits the data.

### SUMMARY OF THE INVENTION

The present invention provides a system and method of sharing data so that users can easily share digital data, such as contents data, between consumer electronics (CE's) by using a server in the Internet. The present invention provides a system and method of sharing data, wherein data transmission schemes are previously defined based on performances of the CE's and stored in the server, and the data is transmitted according to the transmission schemes, so that user participation is minimized.

According to an aspect of the present invention, there is provided a method of sharing data using a server in a broadband network, comprising: generating a space for sharing the data in the server; registering in the server a transmission profile which defines data transmission schemes of data providing terminals and a reception profile which defines data transmission schemes of data receiving terminals; transmitting the data to the server based on the transmission profile registered in the server and storing the data in the server; and transmitting the data stored in the server to the data receiving terminal based on the reception profile registered in the server.

In the aforementioned aspect, the transmitting of the data to the data receiving terminals may comprise: selecting the data receiving terminal to which the data is to be transmitted; searching the reception profile of the selected data receiving terminal; and determining whether to transmit the data based on the searched reception profile.

In an exemplary embodiment, the transmission profile may define data uploading schemes of the data providing terminals.

In an exemplary embodiment, the reception profile may define data types and data transmission schemes of the data receiving terminals.

In an exemplary embodiment, the transmitting of the data to the server may be automatically performed if the data providing terminal accesses the server.

In an exemplary embodiment, the data uploading schemes of the transmission profile may be differently defined depending on performances of the data providing terminals.

In an exemplary embodiment, the data types and the data transmission schemes of the reception profile may be differently defined depending on performances of the data receiving terminals.

According to another aspect of the present invention, there is provided a method of sharing data using a server in a broadband network, comprising: generating a space for sharing the data in the server; registering in the server a transmission profile which defines data transmission schemes of data providing terminals; and transmitting the data to the server based on the transmission profile registered in the server.

According to still another aspect of the present invention, there is provided a method of sharing data using a server in a broadband network, comprising: registering in the server a reception profile which defines data transmission schemes of data receiving terminals; storing the data in the server; and transmitting the data stored in the server to the data receiving terminal based on the reception profile registered in the server.

According to further still another aspect of the present invention, there is provided a system for sharing data using a server in a broadband network, comprising: a data sharing server which provides a space for sharing the data; data providing terminals which transmit generated data to the data sharing server based on a transmission profile which defines data transmission schemes; and data receiving terminals which receive the data from the data sharing server based on a reception profile which defines a data transmission scheme.

In the aforementioned aspect, the transmission profile and the reception profile may be registered in the data sharing server.

In addition, the transmission profile may define data uploading schemes of the data providing terminals, and the data uploading schemes of the transmission profile may be differently defined depending on performances of the data providing terminals.

In addition, the reception profile may define data types and data transmission schemes of the data receiving terminals, and the data types and the data transmission schemes of the reception profile may be differently defined depending on performances of the data receiving terminals.

### BRIEF DESCRIPTION OF THE DRAWINGS

The above and other features and advantages of the present invention will become more apparent by describing in detail exemplary embodiments thereof with reference to the attached drawings in which:

FIG. 1 is a view showing a conventional system for sharing data;

FIG. 2 is a schematic view showing a data sharing system according to an exemplary embodiment of the present invention;

FIG. 3 is a table showing an exemplary profile of data providing terminals according to an exemplary embodiment of the present invention

FIG. 4 is a table showing an exemplary profile of data receiving terminals according to an exemplary embodiment of the present invention;

FIG. 5 is a flowchart of a method of sharing data according to an exemplary embodiment of the present invention; and

FIG. 6 is a view for explaining a flow of data in a data sharing system according to an exemplary embodiment of the present invention.

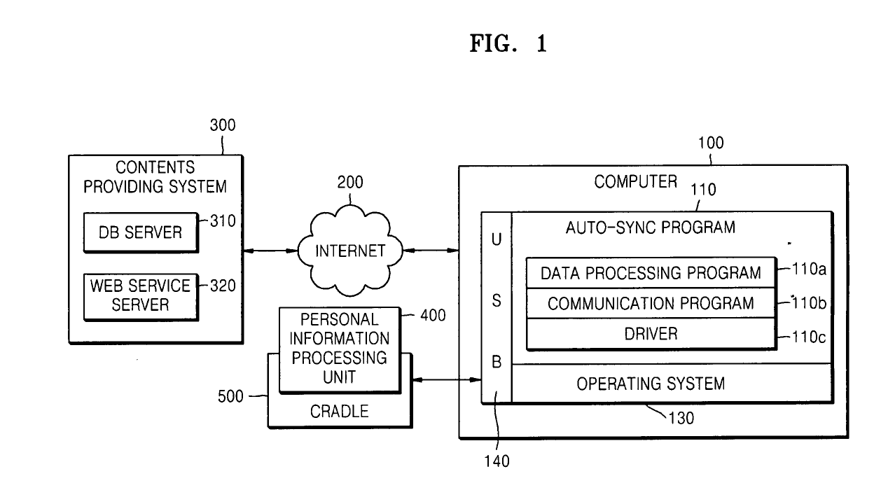

### DETAILED DESCRIPTION OF AN EXEMPLARY EMBODIMENT

An exemplary embodiment of the present invention will be described with reference to the accompanying drawings.

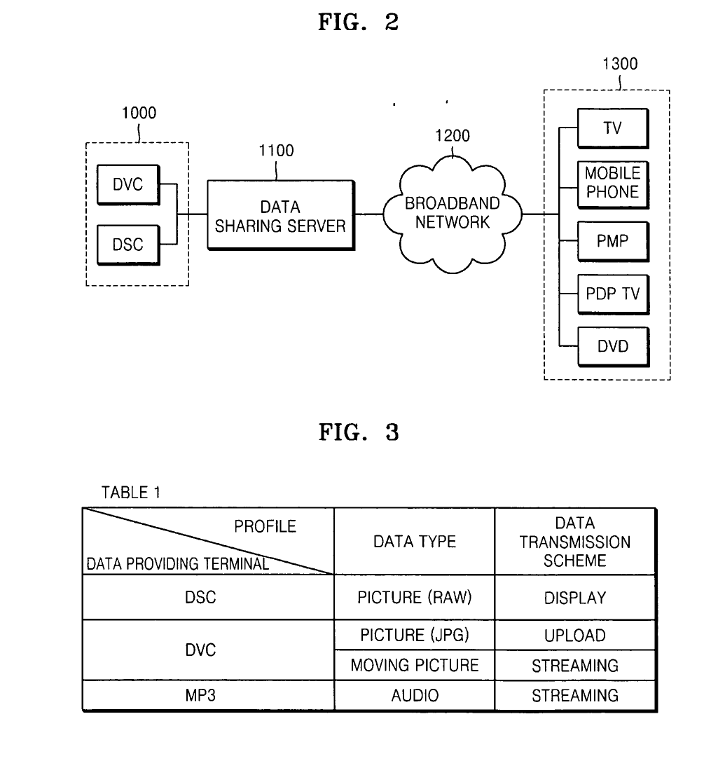

FIG. 2 is a schematic view showing a data sharing system according to an exemplary embodiment of the present invention.

The data sharing system shown in FIG. 2 includes a data providing terminal 1000, a data sharing server 1100, a broadband network 1200, and a data receiving terminal 1300.

In the exemplary embodiment, the data providing terminal 1000 is a digital video camera (DVC) or a digital still camera (DSC), but the present invention is not limited thereto.

The data providing terminal 1000 generates the data, such as contents data, and transmits the generated data to the data sharing server 1100 based on a transmission profile which defines data transmission schemes.

The transmission profile is data which previously defines uploading schemes of the data providing terminals 1000 when the data is transmitted to the data sharing server 1100. Contents of the transmission profile can be freely defined and, in an exemplary embodiment, differently defined depending on performances of the data providing terminals 1000.

For example, as shown in Table 1 of FIG. 3, the transmission profile may be a data which previously defines data uploading schemes for a DVC, a DSC, and an MP3 player. A transmission profile is previously registered in the data sharing server 1100. After that, if the data providing terminal 1000 accesses the data sharing server 1100, the data is transmitted to the data sharing server 1100 based on the previously registered uploading scheme.

The data sharing server 1100 exists in a broadband network and provides a space (sharing account) for sharing the data. In addition, the data sharing server 1100 stores the data transmitted from the data providing terminal 1000.

The data receiving terminal 1300 includes a TV, a mobile phone, a portable multimedia player (PMP), a PDP TV, and a DVD player, but the exemplary embodiment of the present invention is not limited thereto.

The data receiving terminal 1300 receives the data stored in the data sharing server 1100 based on a reception profile which defines data transmission schemes.

The reception profile is data which defines data transmission schemes of the data receiving terminals 1300 when the data is transmitted from the data sharing server 1100 to the data receiving terminal 1300.

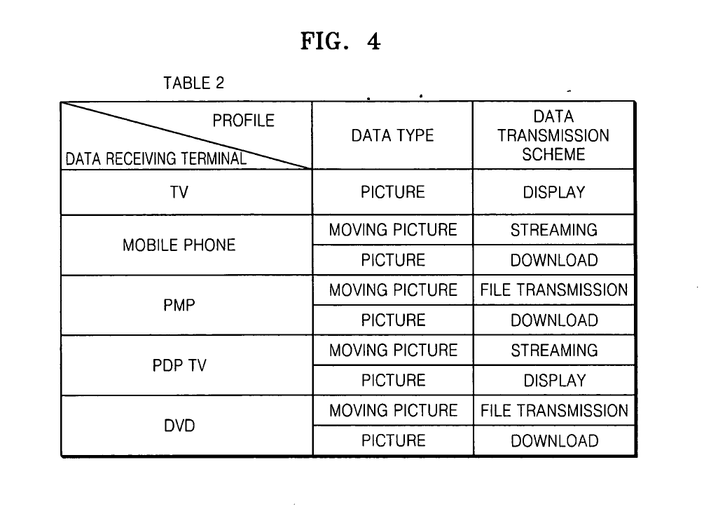

For example, as shown in Table 2 of FIG. 4, the reception profile is data which previously defines data types of the data receiving terminals 1300 and data transmission schemes according to the data types. Contents of the reception profile can be freely defined.

The reception profile is previously registered in the data sharing server 1100, and the data is transmitted to the data receiving terminal 1300 based on the previously registered data transmission scheme.

FIG. 3 is a table showing an exemplary profile of data providing terminals according to an exemplary embodiment of the present invention.

Referring to Table 1 of FIG. 3, in the case of a DSC, the defined data type may be “a raw picture”, and the data transmission scheme for the raw picture may be “display”. In the case of a DVC, the defined data types may be one of “JPG picture” and “moving picture”, and the data transmission scheme may be “upload” for “JPG picture” and “streaming” for “moving picture”. In the case of an MP3 player, the defined data type may be “audio”, and the data transmission scheme may be “streaming”.

The contents of the transmission profile can be freely defined, and in an exemplary embodiment, differently defined depending on performances of the data providing terminals 1000.

FIG. 4 is a table showing an exemplary profile of data receiving terminals according to an exemplary embodiment of the present invention.

Referring to Table 2 of FIG. 4, in the case of a TV, the defined data type is “picture”, and the transmission scheme is “display”. In the case of a mobile phone, the defined data types are “moving picture” and “picture”, and the transmission schemes are “streaming” and “download”. In the case of a PMP, the defined data types are “moving picture” and “picture”, and the transmission schemes are “file transmission” and “download”.

In addition, in the case of a PDP TV, the defined data types are “moving picture” and “picture”, and the transmission schemes are “streaming” and “display”. In the case of a DVD player, the defined data types are “moving picture” and “picture”, and the transmission schemes are “file transmission” and “download”.

The contents of the reception profile can be freely defined, and in an exemplary embodiment, differently defined depending on performances of the data receiving terminals 1300.

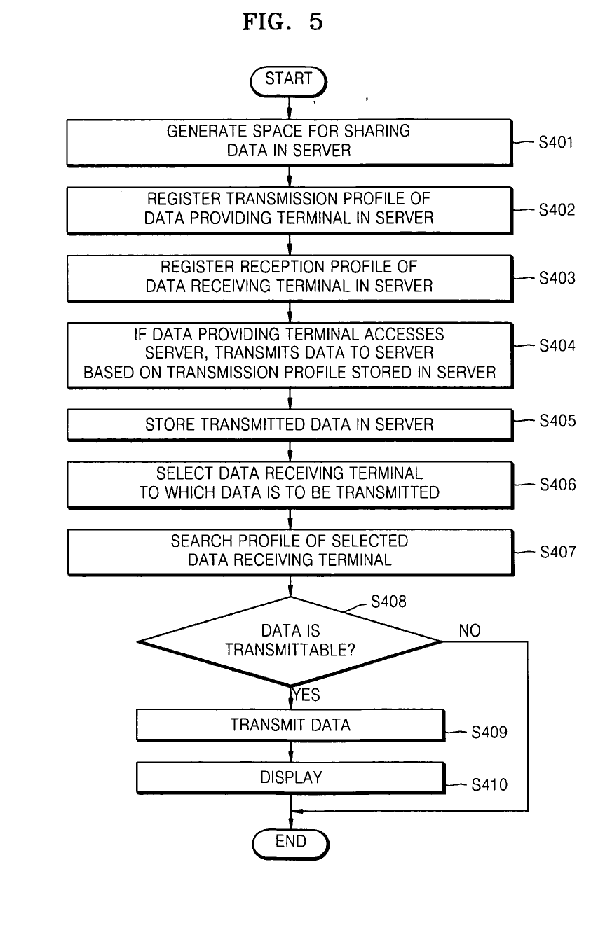

FIG. 5 is a flowchart of a method of sharing data, such as contents data, according to an exemplary embodiment of the present invention.

Firstly, an operation of generating a space for sharing data in the data sharing server 1100 is performed (S401). Namely, a sharing account is generated in the data sharing server 1100.

Next, an operation of registering in the data sharing server 1100 a transmission profile of data providing terminals 1000 which provide data is performed (S402). An operation of registering in the data sharing server 1100 a reception profile of data receiving terminals 1300 which receive data is performed (S403).

The transmission profile is data which defines data transmission schemes of data providing terminals 1000, and the reception profile is data which defines data transmission schemes of data receiving terminals 1300.

In an exemplary embodiment, the transmission profile is data which defines data uploading schemes of the data providing terminals 1000 and may be differently defined depending on performances of the data providing terminals 1000.

In addition, the reception profile is data which defines data types and data transmission schemes of the data receiving terminals 1300 and may be differently defined depending on performances of the data receiving terminals 1300.

After operation S403 is performed, if the data providing terminal 1000 accesses the data sharing server 1100, the data is transmitted to the data sharing server 1100 based on the transmission profile registered in the data sharing server 1100 (S404). Namely, based on the data uploading scheme corresponding to the data providing terminal 1000 registered in the data sharing server 1100, the data is transmitted to the data sharing server 1100.

An operation of storing in the data sharing server 1100 the data transmitted to the data sharing server 1100 is performed (S405).

Next, an operation of selecting a data receiving terminal 1300 to which the data stored in the data sharing server 1100 is to be transmitted is performed (S406).

A reception profile of the data receiving terminal 1300 selected in operation S406 is searched (S407).

It is determined whether the data stored in the data sharing server 1100 can be transmitted to the data receiving terminal 1300 based on the searched reception profile (S408).

As a result of the determination of operation S408, if the data can be transmitted, the data is transmitted to the data receiving terminal 1300 based on the data transmission scheme defined in the reception profile (S409). Next, the data is displayed (S410).

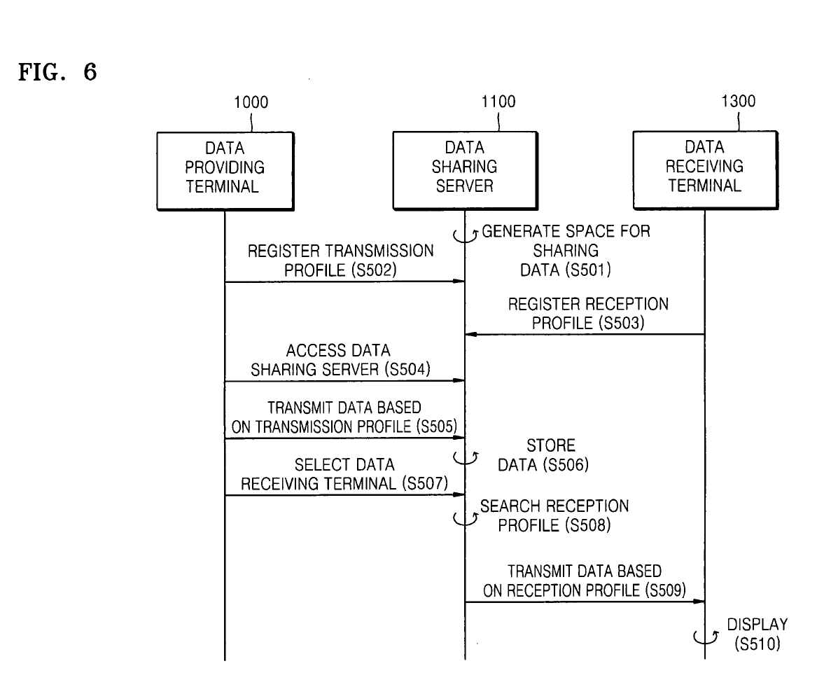

FIG. 6 is a view for explaining a flow of data, such as contents data, in a data sharing system according to an exemplary embodiment of the present invention.

FIG. 6 is similar to FIG. 5, however, FIG. 6 is a view for providing a better understanding of the operations of the data providing terminal 1000, the data sharing server 1100, and the data receiving terminals 1300 and a flow of data in the data sharing system. Therefore, FIG. 6 is described in brief, and a description of contents redundant of FIG. 5 is omitted.

The data sharing server 1100 generates a space for sharing the data (S501).

The data providing terminals 1000 register a transmission profile in the data sharing server 1100 (S502), and data receiving terminals 1300 register a reception profile in the data sharing server 1100 (S503).

The data providing terminal 1000 accesses the data sharing server 1100 (S504), and the data is transmitted based on the transmission profile (S505). The transmitted data is stored in the data sharing server 1100 (S506).

If a data receiving terminal 1300 is selected (S507), the data sharing server 1100 searches the reception profile of the selected data receiving terminal 1300 (S508).

Next, the data is transmitted based on the reception profile (S509), and the data transmitted to the data receiving terminal 1300 is displayed (S510).

While the aforementioned data sharing system and method using a server in a broadband network according to the present invention has been particularly shown and described with reference to exemplary embodiments thereof, it will be understood by those skilled in the art that various changes in form and details may be made therein without departing from the spirit and scope of the present invention as defined by the appended claims.

According to a data sharing system and method using a server in a broadband network of the present invention, data transmission schemes are previously defined based on performances of data providing and receiving terminals and stored in the server, and data is transmitted according to the transmission schemes, so that user participation is minimized. Therefore, data sharing can be easily implemented.

What is claimed is:

1. A method of sharing data using a server in a broadband network, comprising:
generating a space for sharing the data in the server;
registering in the server a transmission profile which defines a data transmission scheme of a data providing terminal, and a reception profile which defines a data transmission scheme of a data receiving terminal;
transmitting the data to the server based on the transmission profile registered in the server and storing the data in the server; and
transmitting the data stored in the server to the data receiving terminal based on the reception profile registered in the server.

2. The method according to claim 1, wherein the transmitting of the data to the data receiving terminal comprises:
selecting from among a plurality of data receiving terminals the data receiving terminal to which the data is to be transmitted;
searching the reception profile of the selected data receiving terminal; and
determining whether to transmit the data based on the searched reception profile.

3. The method according to claim 1, wherein the transmission profile defines a data uploading scheme of the data providing terminal.

4. The method according to claim 1, wherein the reception profile defines a data type and data transmission scheme of the data receiving terminal.

5. The method according to claim 1, wherein the transmitting of the data to the server is automatically performed if the data providing terminal accesses the server.

6. The method according to claim 3, wherein the data uploading scheme of the transmission profile is differently defined depending on performances of the data providing terminal.

7. The method according to claim 4, wherein the data type and the data transmission scheme of the reception profile are differently defined depending on performances of the data receiving terminal.

8. The method according to claim 1, wherein said data comprises contents data.

9. A method of sharing data using a server in a broadband network, comprising:
generating a space for sharing the data in the server;
registering in the server a transmission profile which defines a data transmission scheme of a data providing terminal; and
transmitting the data to the server based on the transmission profile registered in the server.

10. The method according to claim 9, wherein the transmitting of the data to the server is automatically performed if the data providing terminal accesses the server.

11. The method according to claim 9, wherein the transmission profile defines a data uploading scheme of the data providing terminal.

12. The method according to claim 11, wherein the data uploading scheme of the transmission profile is differently defined depending on performances of the data providing terminal.

13. The method according to claim 9, wherein said data comprises contents data.

14. A method of sharing data using a server in a broadband network, comprising:
registering in the server a reception profile which defines a data transmission scheme of a data receiving terminal;
storing the data in the server; and
transmitting the data stored in the server to the data receiving terminal based on the reception profile registered in the server.

15. The method according to claim 14, wherein the transmitting of the data to the data receiving terminal comprises:
selecting from among a plurality of data receiving terminals the data receiving terminal to which the data is to be transmitted;
searching the reception profile of the selected data receiving terminal; and
determining whether to transmit the data based on the searched reception profile.

16. The method according to claim 15, wherein the reception profile defines a data type and a data transmission scheme of the data receiving terminal.

17. The method according to claim 16, wherein the data type and the data transmission scheme of the reception profile are differently defined depending on performances of the data receiving terminals.

18. The method according to claim 14, wherein said data comprises contents data.

19. A system for sharing data using a server in a broadband network, comprising:
a data sharing server which provides a space for sharing the data;
a data providing terminal which transmits generated data to the data sharing server based on a transmission profile which defines a data transmission scheme of the data providing terminal; and
a data receiving terminal which receives the data from the data sharing server based on a reception profile which defines a data transmission scheme of the data receiving terminal.

20. The system according to claim 19, wherein the transmission profile and the reception profile are registered in the data sharing server.

21. The system according to claim 19, wherein the transmission profile defines a data uploading scheme of the data providing terminal.

22. The system according to claim 21, wherein the data uploading scheme of the transmission profile is differently defined depending on performances of the data providing terminal.

23. The system according to claim 19, wherein the reception profile defines a data type and a data transmission scheme of the data receiving terminal.

24. The system according to claim 23, wherein the data type and the data transmission scheme of the reception profile are differently defined depending on performances of the data receiving terminal.

25. The system according to claim 19, wherein said data comprises contents data.
